(19) United States
(12) Patent Application Publication
(10) Pub. No.: US 2009/0044788 A1
(43) Pub. Date: Feb. 19, 2009

(54) ENGINE AIR BOOST SYSTEM

(75) Inventors: John Shutty, Clarkston, MI (US); Philip S. Keller, Clarkston, MI (US); Thomas Grissom, Dexter, MI (US); David White, Dryden, NY (US); David B. Roth, Groton, NY (US)

Correspondence Address: REISING, ETHINGTON, BARNES, KISSELLE, P.C., P. O. BOX 4390, TROY, MI, 48099-4390, US

(73) Assignee: BorgWarner Inc., Auburn Hills, MI (US)

(21) Appl. No.: 12/132,837

(22) Filed: Jun. 4, 2008

Related U.S. Application Data
(60) Provisional application No. 60/956,494, filed on Aug. 17, 2007.

(51) Int. Cl. F02B 33/00; F02M 37/04

(52) U.S. Cl. 123/559.1; 123/495

(57) ABSTRACT

One implementation of an air boost system for an engine includes a boost device and an accumulator adapted to store pressurized fluid and selectively provide pressurized fluid to the boost device. A pump may deliver fluid under pressure to one or both of the accumulator and the boost device in at least some operating conditions. A first control valve may be disposed between the pump and the accumulator to control fluid flow to the accumulator, and a bypass may be provided between the pump and the first control valve. The bypass may, in at least some operating conditions, permit at least some of the pressurized fluid from the pump to bypass the accumulator and be delivered to the boost device. In one form, the accumulator is carried by the boost device in a compact unit.

This application claims the benefit of U.S. provisional application Ser. No. 60/956,494 filed Aug. 17, 2007.

### TECHNICAL FIELD

The field to which this disclosure generally relates includes engine systems including a boost device.

### BACKGROUND

Air boost devices, such as turbochargers, may include hydraulically driven devices, electrically driven devices, belt driven devices and pneumatically driven devices. These devices may be driven directly by the engine, such as with a belt or via a hydraulic pump (which may be driven by the engine), or via an alternator (which is driven by the engine). In any case, the economical use of energy may be important due to sizing considerations, fuel economy considerations and performance considerations.

### SUMMARY OF EXEMPLARY EMBODIMENTS OF THE INVENTION

One implementation of an air boost system for an engine includes a boost device having an output that is delivered to the engine to support operation of the engine and an accumulator adapted to store pressurized fluid and, in at least some operating conditions, provide pressurized fluid to the boost device. A pump may be communicated with the accumulator and the boost device, and is actuated to deliver fluid under pressure to one or both of the accumulator and the boost device in at least some operating conditions. A first control valve may be disposed between the pump and the accumulator to control fluid flow to the accumulator, and a bypass may be provided between the pump and the first control valve. The bypass may, in at least some operating conditions, permit at least some of the pressurized fluid from the pump to bypass the accumulator and be delivered to the boost device. Accordingly, in at least some operating conditions, fluid from the accumulator may be delivered to the boost device.

One exemplary method of providing power to a boost device includes selectively providing pressurized fluid from a pump to the boost device to provide energy to the boost device, selectively providing pressurized fluid from a pump to an accumulator to charge the accumulator with pressurized fluid, and selectively providing pressurized fluid from the accumulator to the boost device to provide power to the boost device. In some implementations of the method the pressurized fluid may be provided from the pump to the accumulator independently from or at the same time that fluid is provided from the pump to the boost device. In some implementations of the method the pressurized fluid may be provided from the accumulator to the boost device independently from or at the same time that pressurized fluid is provided from the pump to the boost device.

Other exemplary embodiments and implementations will become apparent from the detailed descriptions provided herein after. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the inventions will become more fully understood from the detailed description and the accompanying drawings, wherein

FIG. 1 is a schematic diagram of a portion of an engine system including one embodiment of a boost device and associated energy supply system;

FIG. 2 is a schematic diagram of a portion of a boost device and an alternate energy supply system; and

FIG. 3 is a schematic view of a boost device with an integral or unitary energy supply system.

### DETAILED DESCRIPTION OF EXEMPLARY EMBODIMENTS

The following descriptions of the embodiments are merely exemplary in nature and are in no way intended to limit the invention, its application, or uses.

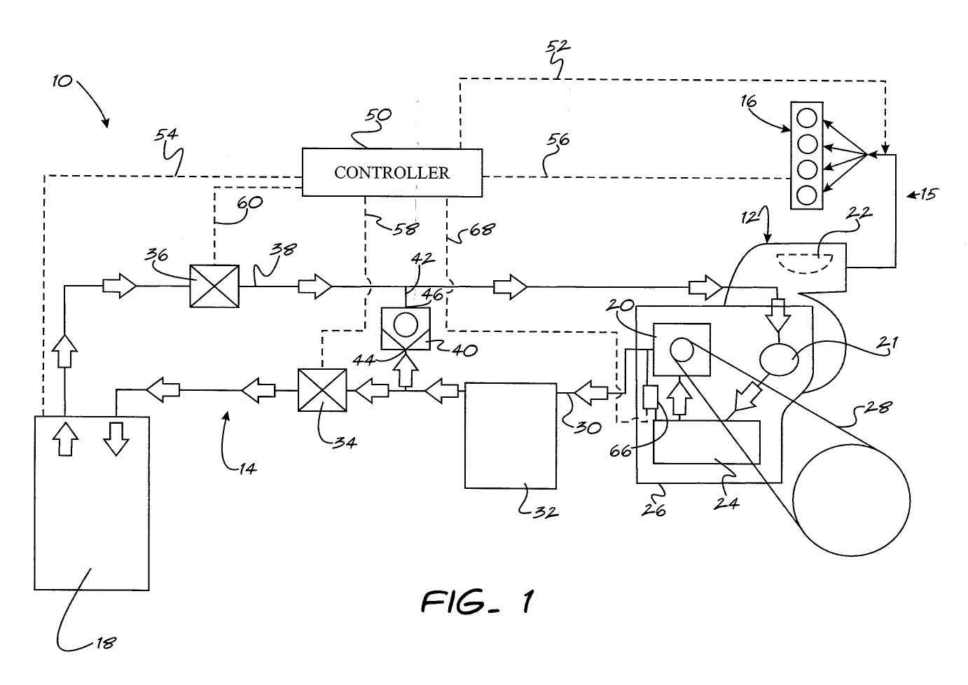

Referring in more detail to the drawings, FIG. 1 illustrates an engine system 10 that includes a boost device 12 and one exemplary embodiment of an energy supply system 14 for the boost assist 12. The boost device 12 may be a turbo-charger or other device and may provide an increased air charge to an intake system 15 of an engine 16 to improve the engine performance. The energy supply system 14 may include an energy storage device 18 and a power device 20 that may jointly or independently provide energy to the boost device 12. The energy supply system 14 may be controlled in different operating states or modes to efficiently store and provide power to the boost device 12. This energy or power may be supplemental or provide a power assist to another energy or power source (such as exhaust gas flow) and can improve boost device performance in situations where, for example, the other source is not sufficient to provide a desired boost device output. This may reduce or eliminate the “lag” or noticeable delay between power commanded and suitable power increase from the engine in at least certain engine operating conditions. Also, the energy supply system 14 can be constructed and arranged to provide energy to the boost device 12 on demand and regardless of the instantaneous or current engine speed and/or load.

The engine 16 may be, but is not limited to, a combustion gasoline or diesel engine. The air intake system 15 may include components and devices located upstream of the engine 16. For example, the air intake system 15 may include plumbing connected to the engine 16 at one end and the plumbing may include an inlet through which air flows. An exhaust system (not shown) may include plumbing connected to the engine at one end and leading to an open end (such as through a muffler and tail pipe). As used herein, the term plumbing includes any suitable conduit, tubes, hoses, passages, manifolds, or the like.

The boost device 12 may include a drive mechanism such as a turbine 21 and a compressor 22. The turbine 21 may be constructed and arranged to be driven by either or both of exhaust gases from the engine and energy from the energy supply system 14 (such as pressurized hydraulic fluid). The compressor 22 may be operably connected to the turbine 21 and driven by the turbine 21 to deliver compressed air to the engine air intake.

The storage device may be an accumulator 18 which may be provided to store power or energy received from the power device 20. Energy stored in the accumulator 18 may be selectively delivered to the boost device turbine 21. In one implementation, the accumulator 18 stores pressurized fluid delivered from a fluid pump 20 that is communicated with and draws fluid from a reservoir 24 that may be contained within or communicated with a body or housing 26 of the boost device 12. The pump 20 may be driven by the engine 16 via a belt 28 or other power transmission member to take-in fluid from the reservoir 24 and discharge it under pressure into a high pressure fill line 30. The fill line 30 may flow through or be communicated with a fluid cooler 32 to control the temperature of the pumped fluid. A first control valve 34 may be disposed in the fill line 30 downstream of the fluid cooler 32 and upstream of the accumulator 18. A second control valve 36 may be provided downstream of the accumulator 18 in a high pressure delivery line 38. The high pressure delivery line 38 may lead to the turbine 21 or other drive mechanism of the boost device 12.

A bypass valve 40 may define at least part of or be provided in a bypass line 42. An inlet 44 of the bypass valve 40 may be communicated with the fill line 30 between the pump 20 and the first control valve 34. An outlet 46 of the bypass valve 40 may be communicated with the delivery line 38 downstream of the second control valve 36. In at least some operating conditions, at least some of the fluid discharged from the pump 20 may flow through the bypass valve 40 and thereby be routed directly to the boost device turbine 21 without flowing through the first control valve 34, the accumulator 18, or the second control valve 36. In one implementation, the bypass valve 40 may be a check valve that is yieldably biased to its closed position preventing fluid flow therethrough until the valve is acted on by fluid pressure above a threshold pressure. The bypass valve 40 could also be any other suitable valve construction such as an electrically controlled or driven valve, like a solenoid driven valve.

The engine system 10 may further include a controller 50 or control system constructed and arranged to control or monitor various systems and components in the engine system 10. For example, at line 52 the controller 50 may monitor and/or be responsive to the boost pressure provided from the boost device 12, at line 54 the pressure or level of energy stored in the accumulator 18, and at line 56 any of various engine operating conditions including, for example, accelerator or throttle position. The controller 50 may also be responsive to, actuate, or control actuation of various components in the engine system 10 including at line 58 the first control valve 34 to control the flow of pressurized fluid therethrough, and at line 60 the second control valve 36 to control the flow of pressurized fluid therethrough. Optionally, the controller 50 may control the operation (extent of opening/closing) of the bypass valve 40. The controller 50 or control system may be the same as, integrated with or separate from the controller used to control the engine 16, or a different vehicle controller(s) or control system(s) for one or more other vehicle systems. The lines 52, 54, 56, 58 and/or 60, as well as any other inputs or outputs of the controller(s), may include wires, conduits or the like, or wireless or other remote communications.

By controlling the operation or position of the first and second control valves 34, 36, including the degree or extent to which they are open, the fluid flow in the energy supply system 14 can be controlled. In one mode of operation, the first control valve 34 is closed so that it prevents fluid flow therethrough, and the second control valve 46 is at least partially open. Hence, pressurized fluid discharged from the pump 20 is prevented from reaching and charging the accumulator 18 and instead flows through the bypass valve 40 to the high pressure delivery line 38 and then the turbine 21. Fluid flow from the accumulator 18, if any, is controlled by the second control valve 36.

In another operational mode, both the first and second control valves 34, 36 are at least partially opened. Accordingly, fluid discharged from the pump 20 flows through the first control valve 34 into the accumulator 18, and fluid flows out of the accumulator 18 and through the second control valve 36. The flow rate through each of the first and second control valves 34,36 can be controlled by controlling the extent to which the valves are open (i.e. either fully open or in a position somewhere between fully opened and fully closed). If desired, the bypass valve 40 can be constructed or controlled to permit some fluid flow therethrough in at least certain operating conditions and when the first control valve 34 is at least partially open. In any event, fluid from the accumulator 18, and optionally directly from the pump 20, may be delivered to the boost device 12 in this operational mode.

In another operational mode, the first and second control valves 34, 36 are controlled such that the flow rate through the first control valve 34 is greater than the flow rate through the second control valve 36. In this case, there is a net flow of fluid into the accumulator 18 to charge the accumulator 18 with pressurized fluid. When sufficient pressure exists in the accumulator 18 and the second control valve 36 is not closed, there will also be some fluid flow out of the accumulator 18, through the second control valve 36, and to the boost device 12. Hence, at least when the second control valve 36 is open, fluid from the accumulator 18 may be delivered to the boost device 12 in this operational mode. It may also be possible to permit some fluid flow through the bypass valve 40 such that fluid from the pump 20 is also delivered through the bypass line 42 and to the boost device 12 in this operational mode.

When the second control valve 36 is closed and the first control valve 34 is at least partially open, the accumulator 18 is charged with at least some of the fluid discharged from the pump 20. The second control valve 36 may be closed, for example, when a vehicle with which the engine 16 is associated is coasting in gear, or braking and in gear. It may be particularly desirable to close the second control valve 36 and charge the accumulator 18 when the vehicle is braking since the energy stored in the accumulator 18 is energy that otherwise would have been lost in the act of braking.

In another operational mode, both the first and second control valves 34, 36 are closed and fluid discharged from the pump 20 is routed to the reservoir 24 through a recirculation valve 66. This mode may be implemented when the accumulator 18 is charged to a maximum energy threshold (for example, about 3,000 psi) and the boost device 12 does not need energy from the energy supply system 14. One example of this situation is when the accumulator 18 is fully charged and the vehicle is braking, coasting or otherwise not demanding power from the engine 16. The recirculation valve may be moved between open and closed positions by the controller, or its position can be monitored by the controller, at line 68.

Accordingly, the boost device 12 may receive energy in the form of pressurized fluid from the pump 20, the accumulator 18, or a combination of both of them. Also, energy from the pump 20 can be used to charge the accumulator 18 both while the accumulator 18 is providing energy to the boost device 12 and when the second control valve 36 is closed such that there is no flow from the accumulator 18 to the boost device 12. The positions of the first and second control valves 34, 36, and, optionally, the bypass valve 40 and recirculation valve 66, may be controlled by the controller 50 as a function of, by way of examples, the engine power load, engine power demand, boost device output, accumulator pressure, and otherwise as desired.

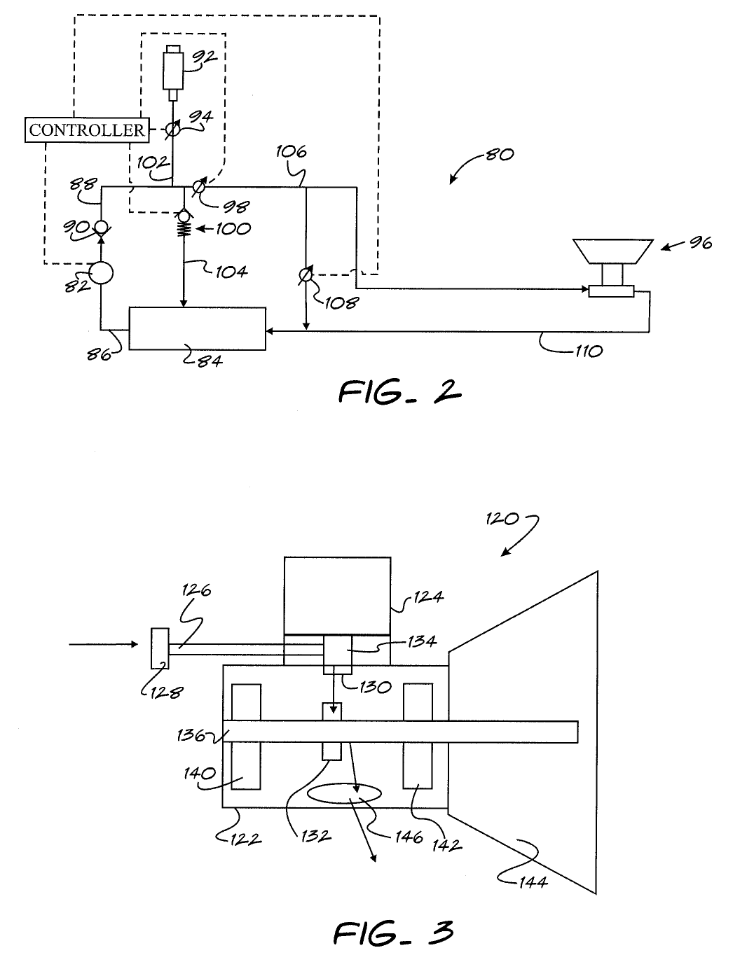

Another implementation of an energy supply system 80 is shown in FIG. 2. In this system, a pump 82 takes in fluid from a reservoir 84 through a low pressure fill line 86. The pump 82 discharges fluid under pressure through a high pressure fill line 88, and a check valve 90 may be provided to prevent the backflow of fluid. The high pressure fill line 88 is communicated with an accumulator 92 through a first control valve 94 and with a boost device 96 through a second control valve 98. The first and second control valves 94, 98 may be separate valves or combined in a single valve or valve body. A pressure relief valve 100 may be provided in communication with the high pressure fill line 88 downstream of a tap or branch 102 to the first control valve 94 and accumulator 92, and upstream of the second control valve 98. The pressure relief valve 100 may be a simple check valve yieldably biased to its closed position, or any other suitable valve type. Fluid at a pressure above a threshold may be routed through the pressure relief valve 100 and a relief line 104 that is communicated with the reservoir 84. Downstream of the second control valve 98, a high pressure delivery line 106 routes fluid to the boost device 96. A recirculation valve 108 may be provided in communication with the high pressure delivery line 106 to permit control of the energy delivered to the boost device 96 in at least some conditions. The recirculation valve 108 may be combined with one or both of the first and second control valves 94, 98 (e.g. as a two or three-way valve). Fluid is returned to the reservoir 84 from the boost device 96 through a low pressure drain line 110.

The pump 82 may be independent of the engine (i.e. not driven by the engine) and may include an electric motor. Hence, the pump 82 may be selectively driven or actuated to selectively provide pressurized fluid into the high pressure fill line 88. A controller 112 may be utilized to actuate or control actuation of the pump 82, and to control the position of any one or more of the first and second control valves 94, 98, the pressure relief valve 100, the recirculation valve 108 or other system components in a manner similar to that described with reference to the power system 14.

In one operational mode, the pump 82 is not actuated and energy is provided to the boost device 96 from the accumulator 92 through the first and second control valves 94, 98. This mode of operation may be implemented, for example, during an initial transient acceleration event when it may not be desirable to divert power from the engine to actuate the pump 82.

In another operational mode, the first control valve 94 is closed and the second control valve 98 is open. When the pump 82 is actuated, the fluid flow bypasses the accumulator 92 and instead flows only through the second control valve 98 and to the boost device 96. Accordingly, the arrangement of passages or conduits and the control valves provides a bypass of the accumulator 92 when desired. This mode of operation may be implemented, for example, during steady state engine operation and/or when the accumulator charge or energy level may not be sufficient to provide the energy needed by the boost device 12, it may not be desirable to use the accumulator energy since it may be needed more in other engine operating conditions, and/or the consumption of engine power to drive the pump 82 does not unduly affect engine operation.

In another operational mode, when the boost device 96 does not require energy from the energy supply system 80, the second control valve 98 is closed and the first control valve 94 is at least partially open. This permits charging of the accumulator 92 when the pump 82 is actuated. When the pressure in the accumulator 92 reaches a desired maximum threshold, the pump 82 may be stopped and/or the pressure relief valve 100 may open to permit fluid flow to the reservoir 84. This mode may be implemented, for example, when the vehicle is braking, coasting or otherwise when power is not demanded from the engine. This mode may also be implemented when the engine and the boost device 96 (without assistance from the energy system 80) can fully meet the power demanded from the engine. Also, if desired in a particular application, this mode may be implemented whenever the vehicle is braking since the energy to run the pump 82 and charge the accumulator 92 may be energy that would otherwise be lost in the act of braking.

In another operational mode, both the first and second valves 94, 98 are at least partially open and the pump 82 is actuated. When the accumulator 92 has relatively less energy stored than is output from the pump 82, the accumulator 92 will be charged and some of the fluid from the pump 82 may be delivered to the boost device 96. When the accumulator 92 has relatively more energy stored than is output from the pump 82, the accumulator 92 will discharge and the boost device 96 will receive fluid from both the pump 82 and the accumulator 92.

FIG. 3 shows another arrangement of a hydraulically powered boost device 120. The boost device 120 may include a body or housing 122. A storage device or accumulator 124 may be connected to, mounted on, carried by, integrated with or into, or otherwise associated with the housing 122. In some implementations, this may provide a compact and unitary assembly.

Pressurized fluid from any suitable source may be received in an inlet 126 of the accumulator 124 and may be stored in the accumulator under pressure. A first control valve 128 may be provided upstream of the inlet 126 to control fluid flow into and hence, charging of the accumulator 124. An outlet 130 of the accumulator 124 is communicated with a turbine 132 of the boost device 120 in at least some operating conditions to drive the turbine 132. A second control valve 134 may control the fluid flow from the accumulator 124 to the turbine 132. The second control valve 134 may be a solenoid valve, and may be driven by a controller or control system as noted with reference to the previous embodiments of FIGS. 1 and 2. While shown separately in the schematic diagram of FIG. 3, the first and second control valves 128, 134 may be integrated into one valve or valve body and the valve may have multiple positions to, for example, permit at least some of the pressurized fluid received in the inlet 126 to bypass the accumulator 124 and flow directly to the turbine 132, cause all or some of the fluid received in the inlet 126 to flow into the accumulator 124, and/or to prevent or control flow of fluid from the accumulator 124 to the boost device 120. The turbine 132 may be operably connected to a drive shaft 136 journalled for rotation by bearings 140, 142, and extending into a compressor section 144 of the boost device 120. Accordingly, hydraulic fluid drives the turbine 132 which in turn drives the compressor 144 via the shaft 136 to provide a compressed air output from the compressor 144. After the fluid is discharged from or exits the turbine 132, it may be routed to an oil sump via an oil drain 146.

The above description of engine system and method embodiments is merely exemplary in nature, and, thus, variations thereof are not to be regarded as a departure from the spirit and scope of the invention. For example, the pump 20, 82 that delivers pressurized fluid to a storage device or accumulator may comprise an existing vehicle pump such as a transmission fluid pump. If desired or necessary, a valve could be controlled to establish a priority of fluid flow to ensure, in one example, that the vehicle transmission is first provided with its pressurized fluid needs before fluid is diverted to the accumulator or other storage device. The fluid provided could also comprise other existing vehicle fluids like fuel from a vehicle fuel system. In that example, the pump 20, 82 may be an existing fuel pump, or an additional pump added to the engine system.

What is claimed is:

1. A boost system for an engine, comprising:
a boost device having an output that is delivered to the engine to support operation of the engine;
an accumulator adapted to store pressurized fluid and, in at least some operating conditions, provide pressurized fluid to the boost device;
a pump communicated with the accumulator and the boost device and actuated to deliver fluid under pressure to one or both of the accumulator and the boost device in at least some operating conditions;
a first control valve disposed between the pump and the accumulator to control fluid flow to the accumulator; and
a bypass between the pump and the first control valve to, in at least some operating conditions, permit at least some of the pressurized fluid from the pump to bypass the accumulator and be delivered to the boost device, and whereby, in at least some operating conditions, fluid from the accumulator may be delivered to the boost device.

2. The system of claim 1 wherein the control valve may be closed to prevent fluid flow to the accumulator and at least partially open to permit fluid flow to the accumulator.

3. The system of claim 2 which also comprises a second control valve disposed downstream of the accumulator and movable between open and closed positions to control fluid flow from the accumulator to the boost device.

4. The system of claim 3 wherein, in one operational mode, the first control valve and second control valve are both closed to prevent fluid flow into or out of the accumulator.

5. The system of claim 3 wherein, in one operational mode, the first control valve is closed to prevent fluid flow into the accumulator, and the second control valve is at least partially open to permit fluid flow from the accumulator to the boost device.

6. The system of claim 5 wherein fluid discharged from the pump is routed through the bypass and to the boost device such that the boost device receives fluid from both the accumulator and the pump.

7. The system of claim 3 wherein, in one operational mode, the first control valve and second control valve are both at least partially open to control fluid flow into and out of the accumulator.

8. The system of claim 7 wherein, in one operational mode, the first control valve permits a greater flow of pressurized fluid into the accumulator than the second control valve permits out of the accumulator and the energy stored in the accumulator increases.

9. The system of claim 3 wherein, in one operational mode, the second control valve is closed and the first control is at least partially open so that at least a portion of the fluid discharged from the pump is delivered to the accumulator.

10. The system of claim 9 wherein the second control valve is closed whenever the vehicle is braking.

11. The system of claim 1 which also comprises a recirculation valve communicating with the pump and arranged so that fluid discharged from the pump is not delivered to either the accumulator or the boost device.

12. The system of claim 1 wherein the boost device is a hydraulically assisted turbocharger.

13. The system of claim 1 wherein the boost device is a hydraulically powered compressor.

14. The system of claim 1 which also includes a controller that controls the position of the control valve.

15. The system of claim 1 wherein the pump is driven by the engine.

16. The system of claim 15 wherein the pump is disposed within a housing that includes a reservoir and a fluid driven drive mechanism to which the pressurized fluid is delivered to drive the boost device and from which fluid flows into the reservoir.

17. The system of claim 1 wherein the pump includes an electric motor.

18. The system of claim 17 which also comprises a controller that controls actuation of the electric motor of the pump to selectively discharge pressurized fluid from the pump.

19. The system of claim 1 wherein the pump also supplies fluid to a transmission associated with the engine.

20. The system of claim 19 which also includes a valve between the pump and the accumulator to control fluid flow between them.

21. The system of claim 2 wherein the pressurized fluid is fuel from a fuel system associated with the engine.

22. The system of claim 21 wherein the pump also supplies fuel to the engine to support operation of the engine.

23. The system of claim 3 wherein the accumulator and second control valve are carried by the boost device.

24. The system of claim 23 wherein the boost device includes a housing and the accumulator is mounted on the housing.

25. The system of claim 1 wherein the first control valve controls fluid flow into and out of the accumulator.

26. The system of claim 25 wherein, depending on the level of energy stored in the accumulator compared to the pressure of fluid discharged from the pump, the accumulator may either be charged or discharged when the first control valve is open.

27. The system of claim 11 which also comprises a controller that controls actuation of the recirculation valve.

28. The system of claim 3 which also comprises a controller that controls the position of the first control valve and the second control valve, the controller being responsive to at least one engine operating condition and the level of energy stored in the accumulator.

29. The system of claim 1 which also includes a bypass valve that prevents fluid flow through the bypass line in at least certain operating conditions.

30. The system of claim 29 wherein the bypass valve prevents fluid flow through the bypass line unless the pressure at the bypass valve is above a threshold.

31. An air boost system for an engine, comprising:
a boost device powered at least in part by fluid and having an output that is delivered to the engine to support operation of the engine;
a delivery line communicating with the boost device;
a pump adapted to provide an output of pressurized fluid;
a fill line communicating with the pump;
an accumulator communicating with the fill line to receive pressurized fluid from the pump in at least certain operating conditions, and communicating with the delivery line in at least some operating conditions to provide pressurized fluid to the boost device;
a first control valve disposed in the fill line to control fluid flow into of the accumulator; and
a second control valve disposed in the delivery line and downstream of the first control valve to control fluid flow through the delivery line wherein the arrangement of the delivery line and fill line permits fluid flow from the fill line into the delivery line when the first control valve is closed to prevent fluid flow into the accumulator so that pressurized fluid may be delivered to the boost device from the pump alone, and when the pump is not operating, pressurized fluid may be delivered to the boost device from the accumulator through the second control valve.

32. The system of claim 31 wherein the first control valve also controls at least in part the fluid flow out of the accumulator.

33. The system of claim 32 wherein fluid flow out of the accumulator flows through both the first and second control valves before being delivered to the boost device.

34. The system of claim 31 which also comprises a pressure relief line communicating with at least one of the fill line or the delivery line and with a supply of fluid communicated with the pump, and a pressure relief valve disposed in the pressure relief line and adapted to open when a pressure at the pressure relief valve is above a maximum to limit the maximum pressure within the system.

35. The system of claim 31 which also comprises a recirculation line communicated with at least one of the fill line or the delivery line and with a supply of fluid communicated with the pump, and a recirculation valve disposed in the recirculation line and adapted to open to permit at least some of the pressurized fluid from one or both of the pump or the accumulator to bypass the boost device.

36. A method of providing power to a boost device, comprising:
selectively providing pressurized fluid from a pump to the boost device to provide power to the boost device;
selectively providing pressurized fluid from a pump to an accumulator to charge the accumulator with pressurized fluid; and
selectively providing pressurized fluid from the accumulator to the boost device to provide power to the boost device.

37. The method of claim 36 wherein, in at least one operational mode, providing pressurized fluid from a pump to the boost device is done independently of providing pressurized fluid from the accumulator to the boost device.

38. The method of claim 36 wherein, in at least one operational mode, providing pressurized fluid from the accumulator to the boost device is done independently of providing pressurized fluid from a pump to the boost device.

39. The method of claim 36 wherein, in at least one operational mode, providing pressurized fluid from a pump to the boost device is done at the same time as providing pressurized fluid from the accumulator to the boost device.

40. The method of claim 36 wherein, in at least one operational mode, providing pressurized fluid from a pump to the boost device is done independently of providing pressurized fluid from a pump to an accumulator.

41. The method of claim 36 wherein, in at least one operational mode, providing pressurized fluid from a pump to the boost device is done at the same time as providing pressurized fluid from a pump to an accumulator.

42. A boost device for an engine, comprising:
a housing;
a shaft disposed at least partially in the housing;
a turbine carried by the housing and coupled to the shaft to drive the shaft for rotation;
an accumulator carried by the housing, having an inlet in which energy is received for storage and an outlet through which energy is discharged, the accumulator being adapted to, in at least certain operating conditions, deliver energy to the turbine to drive the turbine; and
a valve disposed between the outlet and the turbine to control energy delivery from the accumulator to the turbine.

43. The device of claim 42 wherein the energy stored in the accumulator and delivered to the turbine is in the form of pressurized fluid.

44. The device of claim 42 which also includes a valve communicated with the inlet to control the receipt of energy through the inlet.

45. The device of claim 42 wherein the valve is carried by the housing.

46. The device of claim 45 wherein the valve is carried by the accumulator which is carried by the housing.
